(19) United States
(12) Patent Application Publication
(10) Pub. No.: US 2019/0236727 A1
(43) Pub. Date: Aug. 1, 2019

(54) AUTOMATIC NEGOTIATION SYSTEM, AUTOMATIC NEGOTIATION METHOD, AND AUTOMATIC NEGOTIATION PROGRAM

(71) Applicant: NEC Corporation, Minato-ku, Tokyo (JP)

(72) Inventors: Shinji NAKADAI, Tokyo (JP); Satoshi MORINAGA, Tokyo (JP)

(73) Assignee: NEC Corporation, Minato-ku, Tokyo (JP)

(21) Appl. No.: 16/340,424

(22) PCT Filed: Oct. 11, 2017
(86) PCT No.: PCT/JP2017/036805

§ 371 Date: Apr. 9, 2019

(30) Foreign Application Priority Data
Oct. 13, 2016 (JP) 2016-201784

(51) Int. Cl. G06Q 50/06; G06Q 10/10; H02J 3/14

(52) U.S. Cl. CPC G06Q 50/06; H02J 3/14; G06Q 10/10

(57) ABSTRACT

There is provided an automatic negotiation system capable of generating an indicator for defining a favorable target candidate for a supplier. A supply utility function generation means 53 generates a supply utility function expressing a change in profit and loss of the supplier relative to a change in a total demand for each current time and future time. A demand utility function generation means 55 generates a demand utility function expressing a change in profit and loss of the supplier relative to a change in a demand of a consumer for each current time and future time.

### TECHNICAL FIELD

The present invention relates to an automatic negotiation system, an automatic negotiation method, and an automatic negotiation program that perform automatic negotiation with another system.

### BACKGROUND ART

There has been known a technique called the automated demand response (ADR) that automatically controls equipment of consumers in response to a demand change in power. As a message exchange protocol for the ADR, there has been known the OpenADR (see Non Patent Literature 1).

There has also been known a technique of negotiation with respect to a given utility function (see Non Patent Literature 2). There has been a technique of negotiation even in a negotiation in which a plurality of issues to negotiate may exist.

### CITATION LIST

### Non Patent Literature

NPL 1: Ryutarou TOUJI, “OpenADR Standardization Trend”, [Retrieved on Sep. 23, 2016], Internet <URL: http://www.ntt.co.jp/journal/1310/files/jn201310038.pdf>
NPL 2: Hiromitsu HATTORI and two others, “An Auction-Based Negotiation Protocol for Agents with Nonlinear Utility Functions”, [Retrieved on Oct. 12, 2016], Internet <URL: http://www.itolab.nitech.ac.jp/˜ito/papers/hatto-ieice2006.pdf>

### SUMMARY OF INVENTION

### Technical Problem

In order to achieve power saving, the ADR controls equipment of consumers, and gives consumers incentive to save power.

However, instead of controlling equipment of consumers merely for the purpose of power saving, it is preferable to enable automatic negotiation with systems owned by consumers about a demand, price, and the like of power such that a profit of a power supplier is maximized.

In order to achieve such negotiation, it is necessary to set a target candidate in negotiation favorable for the supplier. However, there has been no indicator for defining such a favorable target candidate.

Accordingly, the supplier has not been able to perform automatic negotiation with a system owned by a consumer such that a profit of the supplier is maximized.

Such a problem applies not only to a power supplier but also to water and gas suppliers.

In addition, according to the technique of negotiation with respect to a given utility function mentioned above, the utility function required for the negotiation is not derived with respect to electric energy adjustment.

In view of the above, it is an object of the present invention to provide an automatic negotiation system, an automatic negotiation method, and an automatic negotiation program capable of generating an indicator for defining a favorable target candidate for a supplier.

### Solution to Problem

An automatic negotiation system according to the present invention, which is managed by a first economic entity and performs automatic negotiation with a system managed by a second economic entity, includes a perturbative utility function generation means that derives, with respect to a utility function expressing a relationship between desirability for the first economic entity and a negotiation matter, the utility function from a relationship between an objective function and restriction in an optimized system managed by the first economic entity and a parameter and an optimum value dependent on the second economic entity.

The automatic negotiation system according to the present invention, which performs automatic negotiation with a consumer system managed by a consumer, includes a supply utility function generation means that generates a supply utility function expressing a change in a profit and loss of a supplier relative to a change in a total demand for each current time and future time, and a demand utility function generation means that generates a demand utility function expressing a change in the profit and loss of the supplier relative to a change in a demand of the consumer for each current time and future time.

An automatic negotiation method according to the present invention, which is applied to an automatic negotiation system managed by a first economic entity that performs automatic negotiation with a system managed by a second economic entity, includes a step of deriving, using the automatic negotiation system, with respect to a utility function expressing a relationship between desirability for the first economic entity and a negotiation matter, the utility function from a relationship between an objective function and restriction in an optimized system managed by the first economic entity and a parameter and an optimum value dependent on the second economic entity.

The automatic negotiation method according to the present invention for performing automatic negotiation with a consumer system managed by a consumer includes a step of generating, using a computer, a supply utility function expressing a change in a profit and loss of a supplier relative to a change in a total demand for each current time and future time, and a step of generating a demand utility function expressing a change in the profit and loss of the supplier relative to a change in a demand of the consumer for each current time and future time.

An automatic negotiation program according to the present invention, which is installed on a computer managed by a first economic entity that performs automatic negotiation with a system managed by a second economic entity, causes the computer to perform perturbative utility function generation processing for deriving, with respect to a utility function expressing a relationship between desirability for the first economic entity and a negotiation matter, the utility function from a relationship between an objective function and restriction in an optimized system managed by the first economic entity and a parameter and an optimum value dependent on the second economic entity.

The automatic negotiation program according to the present invention, which is installed on a computer that performs automatic negotiation with a consumer system managed by a consumer, causes the computer to perform supply utility function generation processing for generating a supply utility function expressing a change in a profit and loss of a supplier relative to a change in a total demand for each current time and future time, and demand utility function generation processing for generating a demand utility function expressing a change in the profit and loss of the supplier relative to a change in a demand of the consumer for each current time and future time.

### Advantageous Effects of Invention

According to the present invention, an indicator for defining a favorable target candidate for a supplier can be generated.

### BRIEF DESCRIPTION OF DRAWINGS

FIG. 1 It depicts a block diagram illustrating an exemplary configuration of an automatic negotiation system according to the present invention.

FIG. 2 It depicts an explanatory diagram illustrating examples of a total demand of power of each consumer at the current time, a condition, and a cost function.

FIG. 3 It depicts a schematic diagram illustrating an exemplary supply utility function.

FIG. 4 It depicts an explanatory diagram illustrating examples of a demand of power of a consumer at the current time and a revenue function.

FIG. 5 It depicts a schematic diagram illustrating an exemplary demand utility function.

FIG. 6 It depicts a schematic diagram illustrating an exemplary three-dimensional space represented by a plane defined by a lateral axis and a time axis and a longitudinal axis.

FIG. 7 It depicts a schematic diagram illustrating an exemplary candidate that a negotiation unit aims at in negotiation with a consumer system.

FIG. 8 It depicts a flowchart illustrating exemplary process progress of the automatic negotiation system according to the present invention.

FIG. 9 It depicts a flowchart illustrating exemplary process progress in step S1.

FIG. 10 It depicts a flowchart illustrating exemplary process progress in step S2.

FIG. 11 It depicts a block diagram illustrating an exemplary configuration of an automatic negotiation system including a negotiation controller.

FIG. 12 It depicts a schematic block diagram illustrating an exemplary configuration of a computer according to an exemplary embodiment of the present invention.

FIG. 13 It depicts a block diagram illustrating an outline of the automatic negotiation system according to the present invention.

FIG. 14 It depicts a block diagram illustrating another example of the outline of the automatic negotiation system according to the present invention.

### DESCRIPTION OF EMBODIMENTS

In the exemplary embodiment described below, an exemplary case where an automatic negotiation system according to the present invention is managed by a power supplier and performs automatic negotiation with a consumer system of a consumer of power will be described. However, the automatic negotiation system according to the present invention may be a system managed by a water supplier or a gas supplier.

Note that the consumer system is an automatic negotiation system managed by the consumer. The consumer system is implemented by an information processing apparatus. Examples of the consumer include a business entity that uses power (e.g., business entity having a factory, etc.). However, the consumer is not limited to such a business entity.

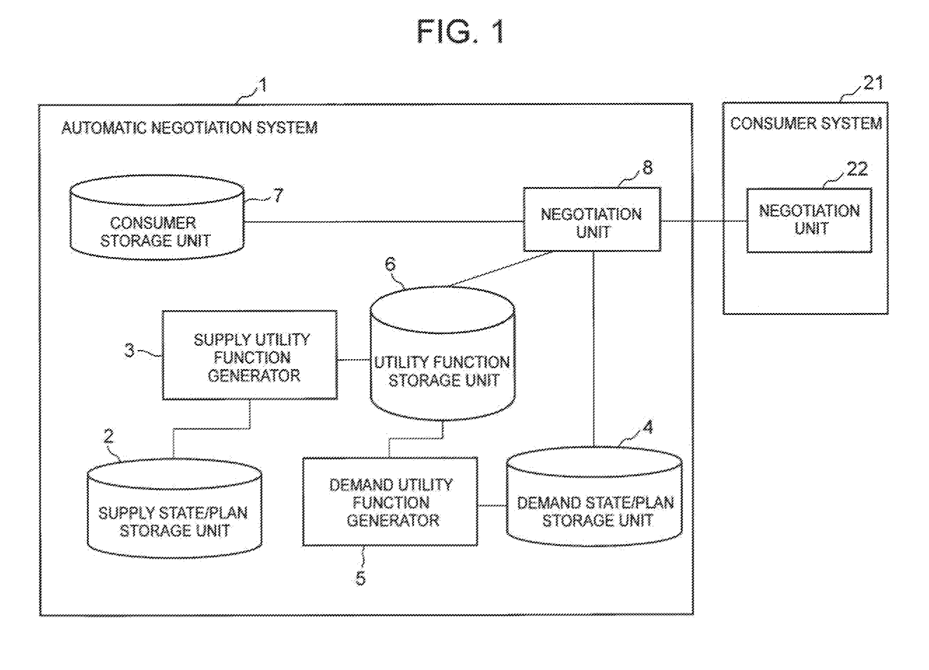

FIG. 1 is a block diagram illustrating an exemplary configuration of the automatic negotiation system according to the present invention. Hereinafter, an exemplary case where an automatic negotiation system 1 according to the present invention performs automatic negotiation with a consumer system 21 of one consumer will be described to simplify the description. However, even if there is only one consumer as a negotiating partner, there are a number of consumers that the supplier is supposed to supply power to. The supplier supplies power according to the demand of each consumer.

The consumer system 21 includes a negotiation unit 22 that performs automatic negotiation with the automatic negotiation system 1 according to the present invention. The consumer system 21 and the automatic negotiation system 1 according to the present invention communicate with each other via a communication network (e.g., the Internet).

The automatic negotiation system 1 according to the present invention includes a supply state/plan storage unit 2, a supply utility function generator 3, a demand state/plan storage unit 4, a demand utility function generator 5, a utility function storage unit 6, a consumer storage unit 7, and a negotiation unit 8.

The supply state/plan storage unit 2 is a storage unit that stores a total demand of power of each consumer at the current time and a future demand plan. The future demand plan is a predicted value of the total demand of power of each consumer at each time in the future from the current time. Note that the predicted value of the total demand at each time is provided as distribution. At the time of focus, the average of the predicted values of the total demand provided as distribution is taken as a predicted value of the total demand at that time.

The supply state/plan storage unit 2 also stores conditions related to power supply, and a cost function. The cost function is a function for obtaining a cost of power supply in response to the demand.

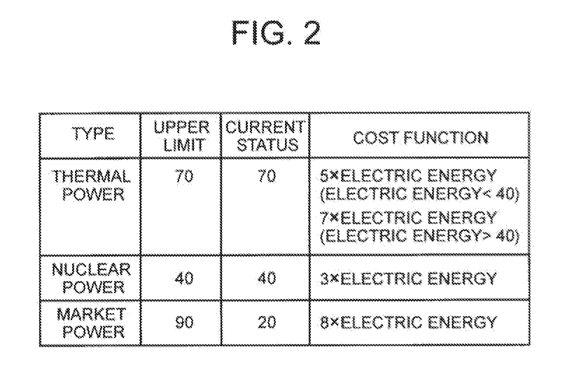

FIG. 2 is an explanatory diagram illustrating examples of the total demand of power of each consumer at the current time, the condition, and the cost function. As described above, the supplier supplies power according to the demand of each consumer. The supply state/plan storage unit 2 stores information indicating the total demand of power of each consumer by a supply for each power type. Here, it is assumed that there are three types of power as the power type, that is, power based on thermal power generation, power based on nuclear power generation, and power procured from the market (hereinafter referred to as market power), and will be described on that basis. The market power is, for example, power obtained by the supplier buying surplus power of solar power generation in a general household. The “current status” column illustrated in FIG. 2 indicates that, at the current time, a power supplier supplies “70” power based on the thermal power generation, “40” power based on the nuclear power generation, and “20” power based on the market power, in response to the total demand. In other words, it is indicated that the total demand at the current time is 70+40+20=130. In this manner, in the example illustrated in FIG. 2, the total supply is indicated by the supply for each power type.

In the present exemplary embodiment, an exemplary case where the supply state/plan storage unit 2 stores the upper limit value of the available power for each power type as a condition for power supply will be described. For example, in FIG. 2, it is indicated that the upper limit value of the available power is “70” with respect to the power based on the thermal power generation at the current time.

Further, the supply state/plan storage unit 2 stores a cost function for each power type. For example, in FIG. 2, it is indicated that the cost (supply cost) associated with the power supply is “3× electric energy” with respect to the nuclear power generation at the current time. In this example, since the supply of power based on the nuclear power generation is “40”, the supply cost for the nuclear power generation is 3×40=120. Note that a coefficient of the cost function may be changed depending on the electric energy (see the cost function of “thermal power” in FIG. 2). If the supply is the same, the supply cost increases in the order of the nuclear power generation, the thermal power generation, and the market power. Therefore, for the supplier, a priority level of the power to be supplied to the consumer is preferably set in the order of the power based on the nuclear power generation, the power based on the thermal power generation, and the market power. This corresponds to obtaining the solution of the following maximization problem. That is, assuming that the total amount of power demand is d, the total amount of a supply cost function ci(si) relative to supply si for each type i is set to Σᵢci(si), and the upper limit value of the supply si is set to σi, there is a maximization problem in which a value satisfying the total cost—Σᵢci(si) is to be maximized under the following restriction.

0≤s i≤σi,∀i, and

Σᵢs i≥d [Expression 1]

For example, as exemplified in FIG. 2, the supply state/plan storage unit 2 stores the condition, the supply of power at the current time, and the cost function for each power type.

Likewise, the supply state/plan storage unit 2 may store, for each future time seen from the present, a condition, a supply of power at that time, and a cost function for each power type. The sum of the supply of power for each power type represents a predicted value of the total demand at that time. It is only necessary to determine the supply of power for each type by allocating the predicted value of the total demand at that time to the type in ascending order of the supply cost to the upper limit value.

Each time in the future seen from the present may be determined to be a time at every constant interval of time (every other hour, etc.).

Meanwhile, the automatic negotiation system 1 may include a means for calculating a predicted value of the total demand at each time in the future and storing, in the supply state/plan storage unit 2, the total demand at each time in the future in the form of the supply of power for each power type. Alternatively, an external system (not illustrated) may calculate the predicted value of the total demand at each time in the future and may cause the supply state/plan storage unit 2 to store the total demand at each time in the future in the form of the supply of power for each power type.

The condition and the cost function may change depending on the time.

The supply utility function generator 3 generates a supply utility function for each current time and future time. The supply utility function is a function expressing a change in a profit and loss of the supplier with respect to a change in the total demand from the standard. When the supply utility function corresponding to the current time is generated, the standard mentioned above is the total demand at the current time. When the supply utility function corresponding to a future time is generated, the standard mentioned above is a predicted value of the total demand at that time.

It can also be said that the supply utility function is a function expressing the amount of change in a profit and loss of the supplier with the amount of change in the total demand from the standard serving as a variable. In other words, the supply utility function is a function expressing the change in the minimum value when a perturbation £ is given to d in the minimization problem described above.

For the current time, the supply utility function generator 3 generates a supply utility function expressing a change in a profit and loss of the supplier with respect to a change in the total demand from the standard with the total demand at the current time serving as the standard.

For the future time, the supply utility function generator 3 generates a supply utility function expressing a change in the profit and loss of the supplier with respect to a change in the total demand from the standard with the predicted value of the total demand at that time serving as the standard.

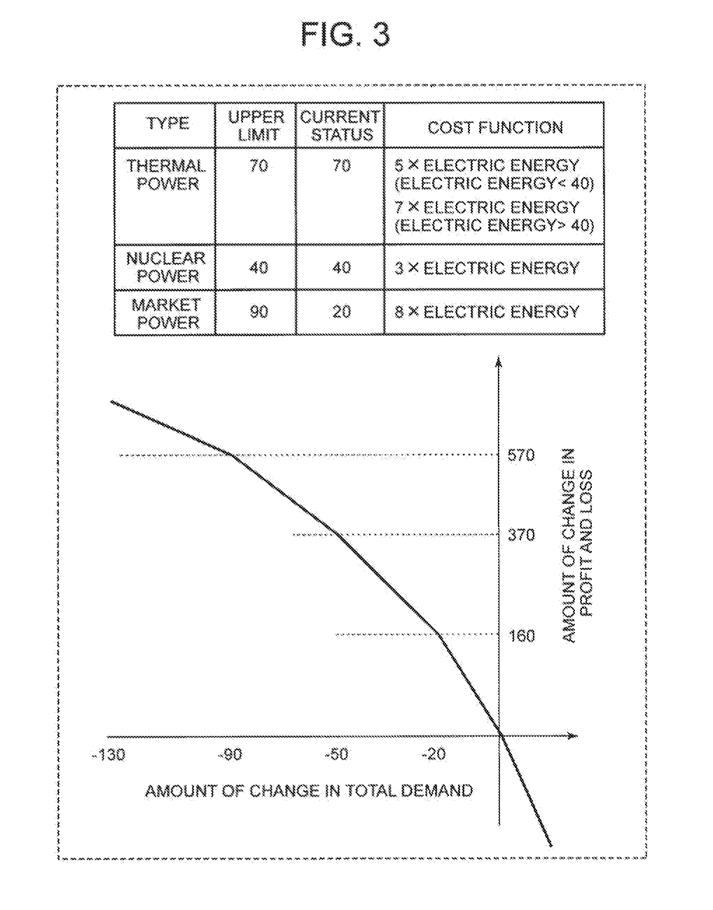

FIG. 3 is a schematic diagram illustrating an example of the supply utility function. The table illustrated in the upper part of FIG. 3 is similar to the table illustrated in FIG. 2. The graph illustrated in the lower part of FIG. 3 illustrates an example of the supply utility function corresponding to the current time.

The lateral axis of the graph illustrated in FIG. 3 represents the amount of change in the total demand from the standard. The standard in the present example is the total demand at the current time, which is, more specifically, 70+40+20=130. Accordingly, the lateral axis of the graph exemplified in FIG. 3 represents the amount of change in the total demand from “130”. The longitudinal axis of the graph represents the amount of change in the profit and loss of the supplier. The amount of change in the profit and loss in the supply utility function is the amount of change in the profit and loss focusing on the supply cost, and fees received from each consumer in exchange for the power are not considered.

As illustrated in the upper part of FIG. 3, at the current time, both of the supply of power based on the nuclear power generation and the supply of power based on the thermal power generation have reached their upper limits. Even in that state, it is insufficient for the total demand, and the market power of “20” is supplied.

When the total demand at the current time is more than the standard, the supplier increases the supply of market power. Besides, the market power is high in the supply cost. Accordingly, when the total demand is more than the standard, a loss of the supplier increases (see the graph illustrated in FIG. 3). On the other hand, when the total demand at the current time is less than the standard, the supplier can reduce the supply of market power whose supply cost is the highest. When the total demand at the current time is even less, the supply of power based on the thermal power generation whose supply cost is the second highest can be reduced. Accordingly, when the total demand is less than the standard, profit of the supplier increases (see the graph illustrated in FIG. 3).

The supply utility function generator 3 generates a supply utility function expressed as a graph exemplified in FIG. 3 as a supply utility function corresponding to the current time.

In a similar manner to the supply utility function corresponding to the current time, the supply utility function generator 3 also generates a supply utility function corresponding to each time in the future seen from the current time.

Specific generation processing of the supply utility function will be described later.

The demand state/plan storage unit 4 is a storage unit that stores a demand of power of a consumer to be a negotiating partner at the current time and a future demand plan of the consumer. In the present example, the consumer to be the negotiating partner is a consumer who manages the consumer system 21. There is only one consumer to be the negotiating partner in the present example, and the consumer may be referred to as a consumer P in the following descriptions. Further, the future demand plan of the consumer is a planned value of the demand planned by the consumer at each time in the future seen from the current time.

The demand state/plan storage unit 4 also stores a revenue function. The revenue function is a function for supplying, to a consumer, power corresponding to the demand of the consumer to be a negotiating partner so that the supplier calculates the revenue obtained from the consumer.

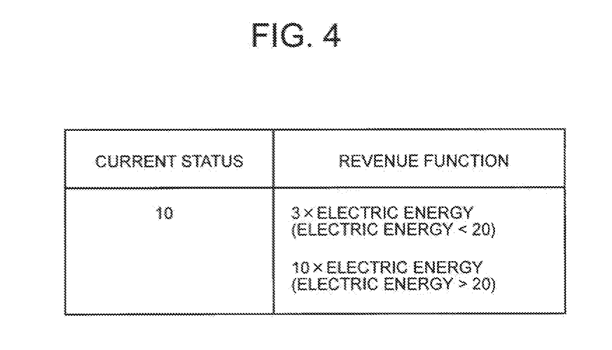

FIG. 4 is an explanatory diagram illustrating examples of the demand of power of the consumer P at the current time and the revenue function. In the example illustrated in FIG. 4, an exemplary case where a coefficient of the revenue function changes according to the demand (in other words, the supply supplied by the supplier according to the demand). In the example illustrated in FIG. 4, the demand of the consumer P at the current time is “10”, which is less than 20, so that the revenue that the supplier obtains from the consumer P is 3×10=30. Further, if the demand of the consumer P at the current time is X and X>20, the revenue that the supplier obtains from the consumer P is 10×X=10X.

For example, as illustrated in FIG. 4, the demand state/plan storage unit 4 stores the demand of power of the consumer P at the current time and the revenue function.

Likewise, the demand state/plan storage unit 4 stores, for each future time seen from the present, a planned value of the demand of the consumer P at a future time and the revenue function. The revenue function may change with time.

For example, the negotiation unit 8 may receive the demand of the consumer P at the current time and the planned value of the demand at each time in the future from the negotiation unit 22 of the consumer system 21, and may store them in the demand state/plan storage unit 4.

The demand utility function generator 5 generates a demand utility function for each current time and future time. The demand utility function is a function expressing a change in the profit and loss of the supplier with respect to a change in the demand of the consumer P from the standard. When the demand utility function corresponding to the current time is generated, the standard mentioned above is the demand of the consumer P at the current time. When the demand utility function corresponding to a future time is generated, the standard mentioned above is a planned value of the demand of the consumer P at that time.

It can also be said that the demand utility function is a function expressing the amount of change in the profit and loss of the supplier with the amount of change in the demand of the consumer P from the standard serving as a variable.

For the current time, the demand utility function generator 5 generates a demand utility function expressing a change in the profit and loss of the supplier with respect to a change in the demand of the consumer P from the standard with the demand of the consumer P at the current time serving as the standard.

For the future time, the demand utility function generator 5 generates a demand utility function expressing a change in the profit and loss of the supplier with respect to a change in the demand of the consumer P from the standard with the planned value of the demand of the consumer P at that time serving as the standard.

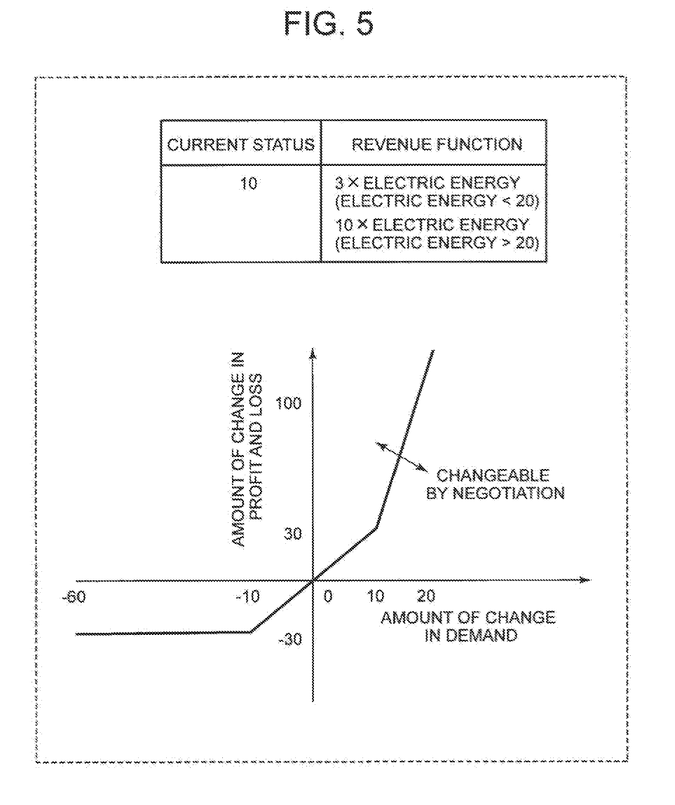

FIG. 5 is a schematic diagram illustrating an example of the demand utility function. The table illustrated in the upper part of FIG. 5 is similar to the table illustrated in FIG. 4. The graph illustrated in the lower part of FIG. 5 illustrates an example of the demand utility function corresponding to the current time.

The lateral axis of the graph illustrated in FIG. 5 represents the amount of change in the demand of the consumer P from the standard. The standard in the present example is the demand of the consumer P at the current time, which is, specifically, “10”. Accordingly, the lateral axis of the graph exemplified in FIG. 5 represents the amount of change in the demand of the consumer P from “10”. The longitudinal axis of the graph represents the amount of change in the profit and loss of the supplier. The amount of change in the profit and loss in the demand utility function is the amount of change in the profit and loss focusing on fees received from one consumer to be a negotiating partner in exchange for the power, and the supply cost is not considered.

When the demand of the consumer P at the current time is less than the standard, the supply supplied to the consumer P from the supplier decreases, and the fees received from the consumer P in exchange for the power also decreases. For example, in the case where the demand of the consumer P at the current time decreases by 10 from the standard, the supply supplied to the consumer P from the supplier is zero, and the profit decreases by 3×10=30 (see the graph illustrated in FIG. 5). At the time when the demand of the consumer P at the current time decreases by 10 from the standard, the supply supplied to the consumer P from the supplier is zero. Therefore, even if the demand of the consumer P at the current time decreases by 10 or more from the standard, the amount of change in the profit and loss of the supplier remains constant at “−30” (see the graph illustrated in FIG. 5).

When the demand of the consumer P at the current time is more than the standard, the supply supplied to the consumer P from the supplier increases, and the fees received from the consumer P in exchange for the power also increases. In other words, the profit increases. In particular, when the amount of change (amount of increase) in the demand of the consumer P exceeds 10, the coefficient of the revenue function increases, thereby increasing the profit (see the graph illustrated in FIG. 5).

The demand utility function generator 5 generates a demand utility function expressed as a graph exemplified in FIG. 5 as a demand utility function corresponding to the current time.

In a similar manner to the demand utility function corresponding to the current time, the demand utility function generator 5 also generates a demand utility function corresponding to each time in the future seen from the current time.

Specific generation processing of the demand utility function will be described later.

The utility function storage unit 6 is a storage unit that stores each supply utility function generated by the supply utility function generator 3 and each demand utility function generated by the demand utility function generator 5.

The consumer storage unit 7 is a storage unit that stores information indicating negotiable consumers. In the present example, the consumer storage unit 7 stores information indicating one consumer P.

The negotiation unit 8 identifies the consumer indicated by the information stored in the consumer storage unit 7, and automatically negotiates with the negotiation unit 22 of the consumer system 21 of the consumer about the demand plan of the consumer P and the change of the revenue function (in other words, fee schedule).

Here, the graph of the supply utility function and the graph of the demand utility function corresponding to the same time are assumed to overlap with each other in such a manner that the origin points, the lateral axes, and the longitudinal axes overlap with each other. Since the supply utility function and the demand utility function are generated for each current time and future time, the graph of the supply utility function and the graph of the demand utility function are assumed to overlap each other as described above for each time. At this time, a three-dimensional space represented by a plane defined by the lateral axis and a time axis and the longitudinal axis can be considered.

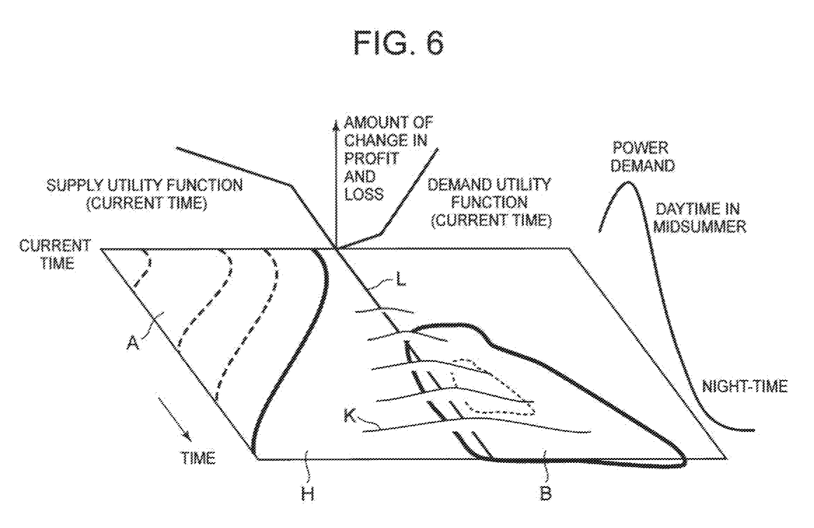

FIG. 6 is a schematic diagram illustrating an example of the three-dimensional space mentioned above.

The negotiation unit 8 adds, for each time, the supply utility function and the demand utility function of the one consumer of focus (in the present example, consumer P). The negotiation unit 8 specifies, as a profit and loss, an area in which a profit of the supplier is generated on a plane H (plane defined by the lateral axis and the time axis of the graph) illustrated in FIG. 6 on the basis of a result of the summation. In other words, the negotiation unit 8 specifies the area in which the summation result is positive.

In the example illustrated in FIG. 6, areas A and B correspond to the area in which the profit of the supplier is generated. Broken lines illustrated in FIG. 6 are contour lines of the profit.

Areas other than the areas A and B correspond to the area in which loss of the supplier is generated.

A line L illustrated in the center of the plane is a line connecting the origin points of the graph at each time. However, the total demand as a standard varies from time to time even if the supplier and the consumer P do not negotiate.

A mound-shaped curve K illustrated in FIG. 6 is predicted distribution of the demand of the consumer P, and particularly illustrates probability distribution of deviation from the average prediction.

An inverse-S-shaped curve illustrated on the right side of FIG. 6 illustrates the prediction average of the total demand. The line L illustrated as an axis is obtained by connecting the predicted value (average) of the total demand at each time as the origin point. Note that the curve indicating the demand plan of the consumer P can also be illustrated like the inverse-S-shaped curve illustrated on the right side of FIG. 6.

In the automatic negotiation with the consumer P (more specifically, consumer system 21), the negotiation unit 8 determines a candidate to be targeted from the summation result of the supply utility function and the demand utility function at each time schematically illustrated in FIG. 6. The negotiation unit 8 may determine a plurality of candidates.

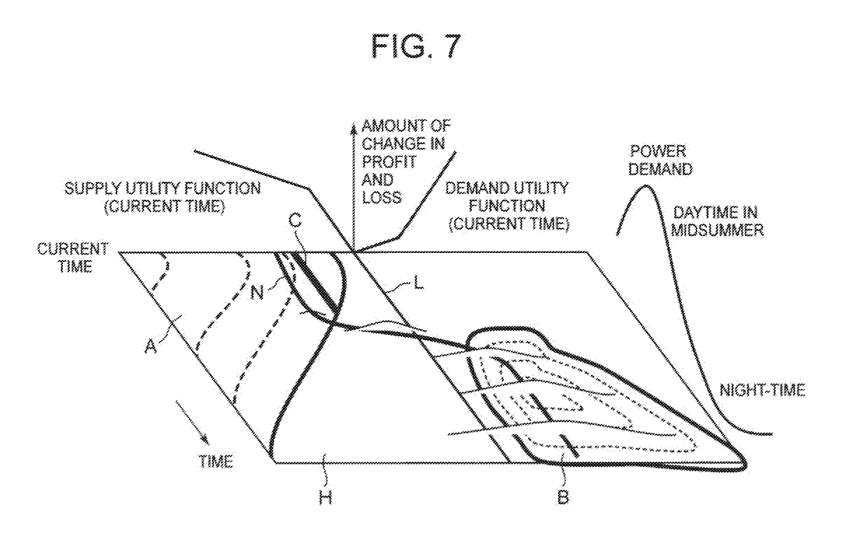

FIG. 7 is a schematic diagram illustrating an example of the candidate that the negotiation unit 8 of the automatic negotiation system 1 aims at in negotiation with the consumer system 21.

A line segment C in FIG. 7 indicates that an upper limit is set for the demand of the consumer P until the time three hours after the current time, for example. Such an upper limit of the demand of the consumer P and a period of time in which such an upper limit is set are defined by the negotiation unit 8, for example. The negotiation unit 8 can perform negotiation such as changing the revenue function to lower power charges in the future (night-time etc.) instead of setting such conditions (in the present example, upper limit of the demand of the consumer P).

The negotiation unit 8 determines, as a target candidate in the negotiation, a change of the planned value of the demand of the consumer P in the future and a change of the revenue function such that the profit of the supplier is maximized. At this time, when the condition (e.g., upper limit of the demand of the consumer P represented by the line segment C illustrated in FIG. 7) is set, the negotiation unit 8 determines a target candidate to satisfy the condition. A curve N illustrated in FIG. 7 schematically illustrates an example of such a candidate.

In comparison with FIG. 6, the range of the area B in which the profit is generated is slightly shifted in FIG. 7. This means that the area B shifts when the negotiation unit 8 includes a change of the revenue function in the future as a target candidate in the negotiation and the revenue function is changed in such a manner.

The negotiation unit 8 determines such a target candidate in the negotiation, and automatically negotiates with the negotiation unit 22 of the consumer system 21. At this time, the negotiation unit 8 presents the determined target candidate to the negotiation unit 22 to carry out the negotiation.

The negotiation operation between the negotiation unit 8 and the negotiation unit 22 of the consumer system 21 after the target candidate is determined may be performed using a publicly known method of automatic negotiation.

The supply utility function generator 3, the demand utility function generator 5, and the negotiation unit 8 are implemented by, for example, a central processing unit (CPU) of a computer that operates in accordance with an automatic negotiation program. In this case, the CPU may read the automatic negotiation program from a program recording medium such as a program storage device (not illustrated in FIG. 1) of the computer, for example, and may operate as the supply utility function generator 3, the demand utility function generator 5, and the negotiation unit 8 in accordance with the program. Further, the supply utility function generator 3, the demand utility function generator 5, and the negotiation unit 8 may be implemented by different pieces of hardware.

Furthermore, the automatic negotiation system 1 may have a configuration in which two or more physically separated apparatuses are connected by wired or wireless connection.

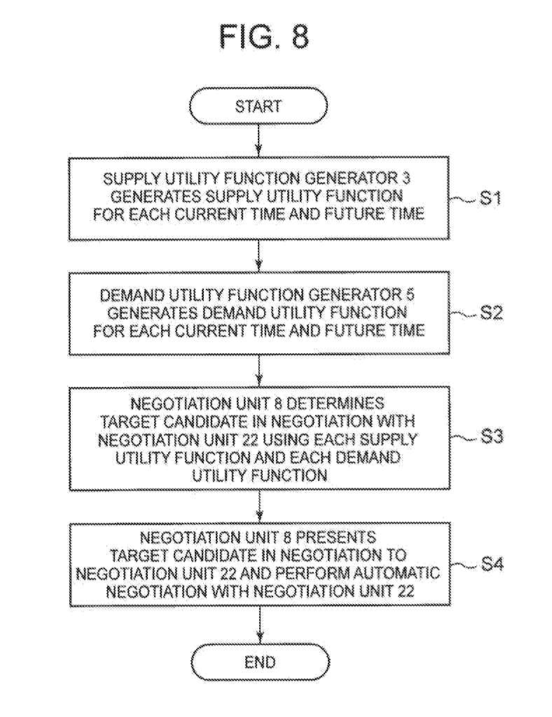

Next, exemplary process progress of the present invention will be described. FIG. 8 is a flowchart illustrating exemplary process progress of the automatic negotiation system 1 according to the present invention. In the present exemplary embodiment, each time (each current time and future time) to be an object of generation of the supply utility function is common to each time to be an object of generation of the demand utility function. Each time mentioned above is preset.

First, the supply utility function generator 3 generates a supply utility function for each current time and future time (step S1). Although an exemplary procedure in which the perturbation £ is applied to the function and a value thereof is obtained in succession to obtain a function value thereof will be described here, the supply utility function generator 3 may analytically perform equivalent processing.

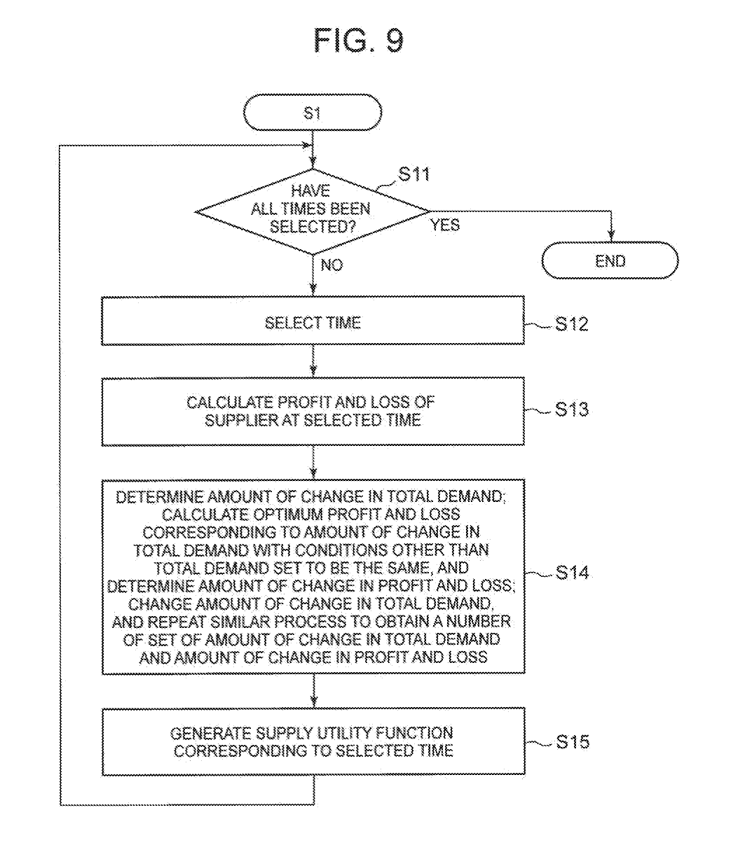

FIG. 9 is a flowchart illustrating an example of the process progress in step S1. In the description of the flowchart illustrated in FIG. 9, a predicted value of the total demand at a future time will be simply referred to as a total demand. The flowchart illustrated in FIG. 9 is an example of the process progress in step S1, and the supply utility function generator 3 may generate a supply utility function at each time using a method other than the method illustrated in FIG. 9.

The supply utility function generator 3 determines whether all of the times (each current time and future time) to be objects of generation of the supply utility function have been selected (step S11).

When unselected time remains (No in step S11), the supply utility function generator 3 selects one time that is a time to be an object of generation of the supply utility function and is not yet selected (step S12).

The supply utility function generator 3 calculates the profit and loss of the supplier at the selected time (step S13).

The supply state/plan storage unit 2 stores the condition, the supply of power, and the cost function at each time to be an object of generation of the supply utility function for each power type. The sum of the supply of power for each power type at the time of focus is the total demand (predicted value of the total demand if the time is a future time). In step S13, the supply utility function generator 3 focuses on the correspondence relationship between the condition, the supply of power, and the cost function for each power type at the selected time. Then, the supply utility function generator 3 assigns the supply of power to the cost function for each power type to calculate the supply cost for each type, and determines the sum of the supply costs as a profit and loss at the selected time. Hereinafter, the profit and loss calculated in step S13 will be denoted by a reference sign α.

After step S13, the supply utility function generator 3 executes processing of step S14 to be described below.

In step S14, first, the supply utility function generator 3 determines an amount of change in the total demand. As described above, the sum of the supply of power for each power type at the time of focus is the total demand (predicted value of the total demand if the time is a future time). The supply utility function generator 3 determines the amount of change in the total demand with the total demand serving as the standard. For example, it is assumed that the selected time is the current time and the total demand is 70+40+20=130 (see the table illustrated in the upper part of FIG. 3). In this case, the supply utility function generator 3 defines, for example, “−10” as the amount of change from the standard (130). Here, an exemplary case where, as described above, the supply utility function generator 3 defines “−10” as the amount of change in the total demand will be described.

In step S14, the supply utility function generator 3 calculates the optimum profit and loss for the supplier according to the amount of change in the total demand, assuming the conditions other than the total demand to be the same. Since the conditions other than the total demand are assumed to be the same, the supply utility function generator 3 does not change the upper limit, the cost function (see the table illustrated in the upper part of FIG. 3), and the like. As described above, there are a plurality of methods for reducing the demand by 10 from the total demand (70+40+20=130) in the case where the amount of change in the total demand is defined to be “−10”. For example, the amount of change in the total demand is “−10” even if the supply of power based on the thermal power generation “70” is reduced to “60”, the supply of power based on the nuclear power generation “40” is reduced to “30”, or the supply of power based on the market power “20” is reduced to “10”. However, the profit and loss of the supplier fluctuates depending on the manner of changing the total demand.

When the amount of change in the total demand is negative, the supply utility function generator 3 may change the supply for each type such that the sum of the amount of decrease from the supply for each type becomes the absolute value of the amount of change. At this time, in order to calculate the optimum profit and loss for the supplier, the supply utility function generator 3 decreases the supply from the type in descending order of the supply cost. The magnitude of the supply cost can be determined by the coefficient of the cost function, and the supply utility function generator 3 may determine that the supply cost is large as the coefficient of the cost function is larger. In the example illustrated in FIG. 3, when the types are ranked in descending order of the supply cost, it is the market power, the thermal power generation, and the nuclear power generation in that order. Therefore, for example, when the amount of change in the total demand is “−10”, the supply utility function generator 3 may determine that the supply of the market power is to be changed from “20” to “10”. Further, for example, when the amount of change in the total demand is “−100”, the supply utility function generator 3 may determine that the supply of the market power is to be changed from “20” to “0”, the supply of power based on the thermal power generation is to be changed from “70” to “0”, and the supply of power based on the nuclear power generation is to be changed from “40” to “30”. Note that this change is a computational change, and the supply of power is not actually changed according to this change. After defining the supply after the change in this manner, the supply utility function generator 3 assigns the supply after the change to the cost function for each power type to calculate the supply cost for each type, and calculates the sum of the supply costs. The sum of the supply costs is the optimum profit and loss.

When the amount of change in the total demand is positive, the supply utility function generator 3 may change the supply for each type such that the sum of the amount of increase from the supply for each type becomes the absolute value of the amount of change. At this time, in order to calculate the optimum profit and loss for the supplier, the supply utility function generator 3 increases the supply from the type in ascending order of the supply cost within the range of the upper limit. In the example illustrated in FIG. 3, when the types are ranked in ascending order of the supply cost, it is the nuclear power generation, the thermal power generation, and the market power in that order. For example, the amount of change in the total demand is assumed to be “10”. At this time, the supply costs of the nuclear power generation and the thermal power generation are lower than that of the market power. However, in the example illustrated in FIG. 3, the supply of the nuclear power generation and the thermal power generation have reached the upper limit. Therefore, the supply utility function generator 3 may determine that the supply of the market power is to be changed from “20” to “30”. Further, the supplies of power based on the nuclear power generation, power based on the thermal power generation, and the market power are assumed to be “30”, “0”, and “0”, respectively, and the amount of change in the total demand is assumed to be “100”, for example. In this case, the supply utility function generator 3 may determine that the supply of power based on the nuclear power generation is changed from “30” to the upper limit “40”, the supply of power based on the thermal power generation is changed from “0” to the upper limit “70”, and the supply of the market power is changed from “0” to “20”. As described above, this change is a computational change, and the supply of power is not actually changed according to this change. After defining the supply after the change in this manner, the supply utility function generator 3 assigns the supply after the change to the cost function for each power type to calculate the supply cost for each type, and calculates the sum of the supply costs. The sum of the supply costs is the optimum profit and loss.

The method of calculating the optimum profit and loss has been described with the examples for each of the case where the amount of change in the total demand is negative and the case where the amount of change in the total demand is positive. This optimum profit and loss is denoted by a reference sign β.

In step S14, the supply utility function generator 3 calculates the optimum profit and loss (3, and subtracts the profit and loss a calculated in step S13 from the optimum profit and loss (3, thereby obtaining the amount of change in the profit and loss.

As a result, the supply utility function generator 3 can obtain a set of the amount of change in the total demand initially defined and the amount of change in the profit and loss corresponding to the amount of change in the total demand. The supply utility function generator 3 stores the set.

The supply utility function generator 3 changes the amount of change in the total demand, and repeats the process described above, thereby obtaining a number of sets of the amount of change in the total demand and the amount of change in the profit and loss corresponding to the amount of change in the total demand. The processing of step S14 is complete here. The number of sets of the amount of change in the total demand and the amount of change in the profit and loss to be obtained may be determined in advance.

Next, the supply utility function generator 3 generates a supply utility function corresponding to the selected time on the basis of each set of the amount of change in the total demand and the amount of change in the profit and loss (step S15). In step S15, the supply utility function generator 3 stores the selected time and the supply utility function, which are associated with each other, in the utility function storage unit 6.

After step S15, the supply utility function generator 3 repeats the processing of step S11 and the subsequent steps. When there is no unselected time in step S11 (Yes in step S11), the supply utility function generator 3 terminates the processing of step S1 (see FIG. 8). As a result, the utility function storage unit 6 enters a state in which the supply utility functions corresponding to each current time and future time are stored therein.

After step S1, the demand utility function generator 5 generates a demand utility function for each current time and future time (step S2).

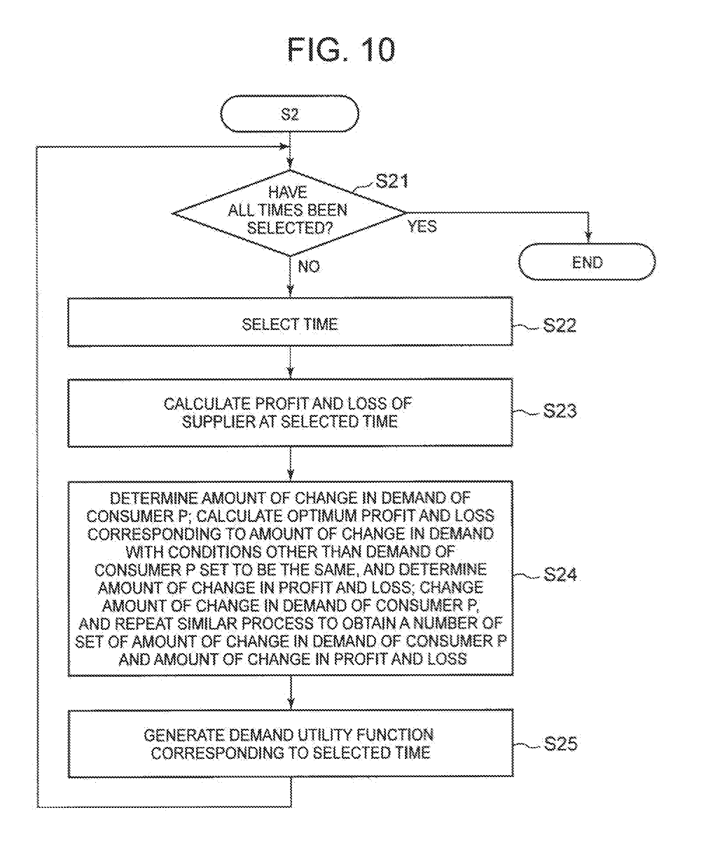

FIG. 10 is a flowchart illustrating exemplary process progress in step S2. In the description of the flowchart illustrated in FIG. 10, a planned value of the demand of the consumer P at a future time will be simply referred to as a demand. The flowchart illustrated in FIG. 10 is an example of the process progress in step S2, and the demand utility function generator 5 may generate a demand utility function at each time using a method other than the method illustrated in FIG. 10.

The demand utility function generator 5 determines whether all of the times (each current time and future time) to be objects of generation of the demand utility function have been selected (step S21).

When unselected time remains (No in step S21), the demand utility function generator 5 selects one time that is a time to be an object of generation of the demand utility function and is not yet selected (step S22).

The demand utility function generator 5 calculates the profit and loss of the supplier at the selected time (step S23).

The demand state/plan storage unit 4 stores the demand of the consumer P (in other words, supply supplied by the supplier in response to the demand) at each time to be an object of generation of the demand utility function, and the revenue function. In step S23, the demand utility function generator 5 assigns the demand of the consumer P at the selected time to the revenue function, thereby calculating the profit and loss of the supplier at the selected time. Hereinafter, the profit and loss calculated in step S23 will be denoted by a reference sign α′.

After step S23, the demand utility function generator 5 executes processing of step S24 to be described below.

In step S24, first, the demand utility function generator 5 determines an amount of change in the demand of the consumer P. Here, it is assumed that the selected time is the current time and the demand of the consumer P is “10” (see the table illustrated in the upper part of FIG. 5). The demand utility function generator 5 defines the amount of change from the standard (10). For example, the demand utility function generator 5 defines “−5” as the amount of change from the standard (10).

In step S24, the demand utility function generator 5 calculates the optimum profit and loss for the supplier according to the amount of change in the demand, assuming the conditions other than the demand of the consumer P to be the same. Since the conditions other than the demand are assumed to be the same, the demand utility function generator 5 does not change the revenue function (see the table illustrated in the upper part of FIG. 5), and the like. The demand utility function generator 5 adds the defined amount of change to the standard (in the present example, 10) to define the demand after the change. However, this change is a computational change, and the demand of the consumer P is not actually changed according to this change.

Regardless of whether the amount of change of the demand is negative or positive, the demand utility function generator 5 may add the amount of change to the standard to define the demand after the change. For example, when the amount of change in the demand is “−5”, the demand after the change is 10-5=5. For example, when the amount of change in the demand is “−10”, the demand after the change is 10-10=0. For example, when the amount of change in the demand is “5”, the demand after the change is 10+5=15.

Note that the lower limit of the demand of the consumer P is zero. Therefore, when the amount of change in the demand is negative, the absolute value thereof is large, and the demand after the change is negative, the demand utility function generator 5 sets the demand after the change to zero. For example, in the example above, the amount of change in the demand is assumed to be “−30”. Although the result of adding the amount of change “−30” to the standard “10” is “−20”, the demand utility function generator 5 does not set the demand after the change to −20, but sets it to zero.

The demand utility function generator 5 assigns the demand after the change to the revenue function, thereby calculating the optimum profit and loss for the supplier. This optimum profit and loss is denoted by a reference sign β′.

In step S24, the demand utility function generator 5 calculates the optimum profit and loss (3′, and subtracts the profit and loss a′ calculated in step S23 from the optimum profit and loss (3′, thereby obtaining the amount of change in the profit and loss.

As a result, the demand utility function generator 5 can obtain a set of the amount of change in the demand of the consumer P initially defined and the amount of change in the profit and loss corresponding to the amount of change in the demand. The demand utility function generator 5 stores the set.

The demand utility function generator 5 changes the amount of change in the demand of the consumer P, and repeats the process described above, thereby obtaining a number of sets of the amount of change in the demand of the consumer P and the amount of change in the profit and loss corresponding to the amount of change in the demand. The processing of step S24 is complete here. The number of sets of the amount of change in the demand of the consumer P and the amount of change in the profit and loss to be obtained may be determined in advance.

Next, the demand utility function generator 5 generates a demand utility function corresponding to the selected time on the basis of each set of the amount of change in the demand of the consumer P and the amount of change in the profit and loss (step S25). In step S25, the demand utility function generator 5 stores the selected time and the demand utility function, which are associated with each other, in the utility function storage unit 6.

After step S25, the demand utility function generator 5 repeats the processing of step S21 and the subsequent steps. When there is no unselected time in step S21 (Yes in step S21), the demand utility function generator 5 terminates the processing of step S2 (see FIG. 8). As a result, the utility function storage unit 6 enters a state in which the demand utility functions corresponding to each current time and future time are stored therein.

After step S2, the negotiation unit 8 determines a target candidate in the negotiation with the negotiation unit 22 of the consumer system 21 using each supply utility function and each demand utility function (step S3). For example, the negotiation unit 8 adds the supply utility function and the demand utility function at each time, and determines an area in which a profit of the supplier is generated on the plane exemplified in FIG. 6. Then, when the condition (e.g., upper limit of the demand of the consumer P represented by the line segment C illustrated in FIG. 7) is set, the negotiation unit 8 defines change contents of the planned value of the demand of the consumer P in the future and change contents of the revenue function as a target candidate in the negotiation in such a manner that the condition is satisfied and the profit of the supplier is maximized. The negotiation unit 8 may determine a plurality of target candidates in the negotiation in step S3.

Then, the negotiation unit 8 presents the target candidate determined in step S3 to the negotiation unit 22 of the consumer system 21, and performs automatic negotiation with the negotiation unit 22 (step S4). As described above, negotiation operation between the negotiation unit 8 and the negotiation unit 22 may be performed using a publicly known method of automatic negotiation.

According to the present exemplary embodiment, the supply utility function generator 3 generates the supply utility function for each current time and future time, and the demand utility function generator 5 generates the demand utility function for each current time and future time. Then, the negotiation unit 8 determines the target candidate in the negotiation using the supply utility function at each time and the demand utility function at each time. Therefore, it can be said that each supply utility function and each demand utility function are indicators for defining a favorable target candidate for the supplier, and according to the present invention, such indicators (each supply utility function and each demand utility function) can be generated.

Next, variations of the exemplary embodiment of the present invention will be described.

In the exemplary embodiment described above, the case where the negotiation unit 8 determines a target candidate in the negotiation using each supply utility function and each demand utility function has been described. A negotiation unit 8 may determine a target candidate in negotiation using each demand utility function, without using each supply utility function. When the demand utility function for each time can be obtained, the negotiation unit 8 can determine an area in which a profit of a supplier is generated in the plane exemplified in FIG. 6, and can determine the target candidate in the negotiation. In other words, the negotiation unit 8 may determine the target candidate in the negotiation using at least the demand utility function at each time. The other points are similar to those in the exemplary embodiment described above.

In addition, in the exemplary embodiment described above, the case where the automatic negotiation system 1 according to the present invention performs automatic negotiation with the consumer system 21 of one consumer has been described. There may be a plurality of consumers (more specifically, consumer systems) to be a negotiating partner, and an automatic negotiation system 1 may negotiates with each of the plurality of consumer systems. It is assumed that each consumer to be a negotiating partner manages a consumer system similar to a consumer system 21 illustrated in FIG. 1.

In that case, a demand state/plan storage unit 4 may store information described in the exemplary embodiment described above for each negotiable consumer. Further, a demand utility function generator 5 may execute processing of step S2 for each negotiable consumer. In other words, the demand utility function generator 5 may execute the process of the flowchart exemplified in FIG. 10 for each negotiable individual consumer.

A consumer storage unit 7 may store information indicating a plurality of consumers in advance as information indicating negotiable consumers. The negotiation unit 8 may identify each consumer to be a negotiating partner on the basis of the information, and may perform automatic negotiation with each consumer system corresponding to each of the consumers.

The negotiation unit 8 may use each demand utility function corresponding to each time generated for the consumer of focus when a target candidate in the negotiation is defined for each individual consumer. The negotiation unit 8 may use each supply utility function corresponding to each time in common irrespective of consumers. For example, when negotiating with a consumer system of a consumer P1, the negotiation unit 8 may determine a target candidate in the negotiation using each supply utility function corresponding to each time and each demand utility function corresponding to each time generated for the consumer P1.

Furthermore, when there are a plurality of consumer systems to be negotiating partners, the automatic negotiation system 1 may include a negotiation controller that provides a specific instruction to the negotiation unit 8 while the negotiation unit 8 is performing negotiation with each of the plurality of consumer systems. FIG. 11 is a block diagram illustrating an exemplary configuration of the automatic negotiation system 1 including the negotiation controller.

Elements similar to those illustrated in FIG. 1 are denoted by the reference signs same as those in FIG. 1, and descriptions thereof will be omitted. Both of consumer systems 21a and 21b illustrated in FIG. 11 are similar to the consumer system 21 illustrated in FIG. 1. Note that illustration of a negotiation unit 22 included in each of the consumer systems 21a and 21b is omitted in FIG. 11.

As illustrated in FIG. 11, the automatic negotiation system 1 includes a negotiation controller 9. The negotiation controller 9 provides a specific instruction to the negotiation unit 8 while the negotiation unit 8 is performing negotiation with the plurality of consumer systems 21a and 21b, and the like. For example, the negotiation controller 9 may instruct the negotiation unit 8 to negotiate with the consumer system 21a to increase a demand by 10, and to negotiate with the consumer system 21b to decrease a demand by 10. The contents instructed to the negotiation unit 8 by the negotiation controller 9 is not limited to the example described above.

The negotiation controller 9 is implemented by, for example, a CPU of a computer that operates in accordance with an automatic negotiation program.

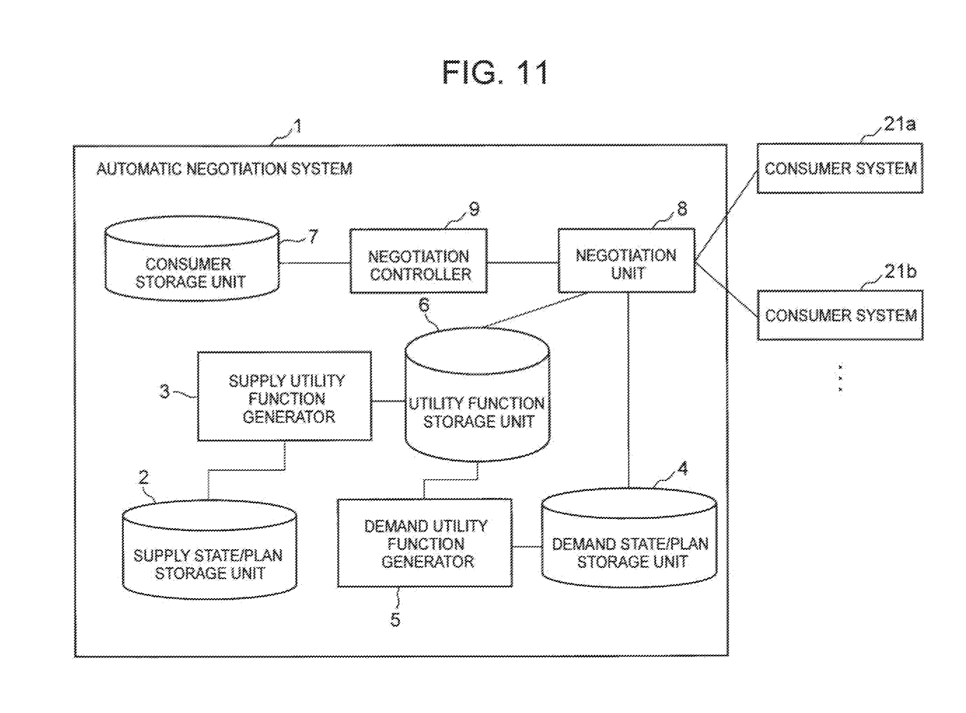

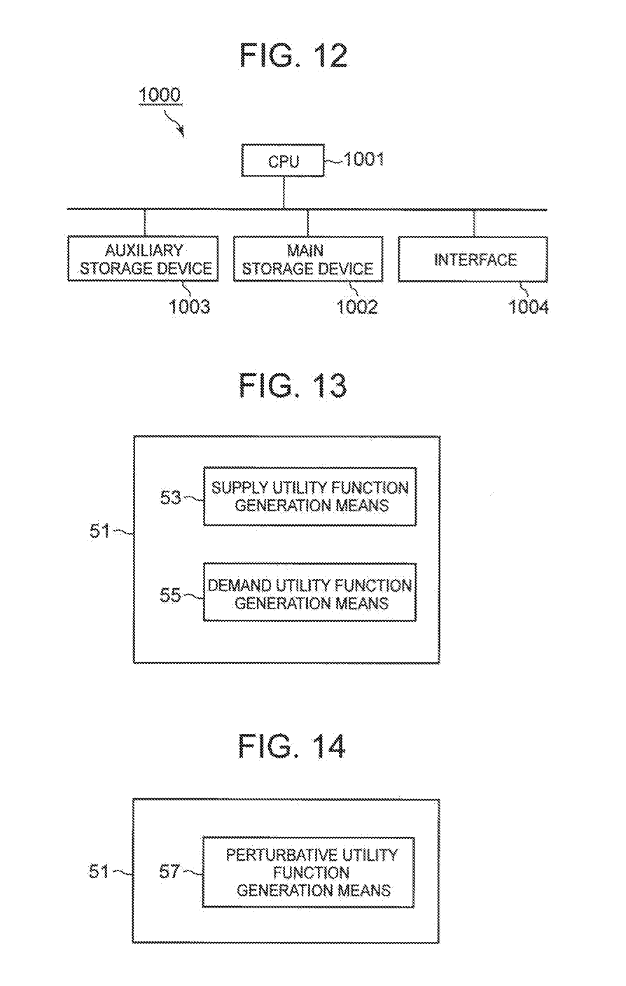

FIG. 12 is a schematic block diagram illustrating an exemplary configuration of a computer according to an exemplary embodiment of the present invention. A computer 1000 includes a CPU 1001, a main storage device 1002, an auxiliary storage device 1003, and an interface 1004.

The automatic negotiation system 1 according an exemplary embodiment of the present invention is implemented in the computer 1000. Operation of the automatic negotiation system 1 is stored in the auxiliary storage device 1003 in the form of a program (automatic negotiation program). The CPU 1001 reads the program from the auxiliary storage device 1003, loads the program in the main storage device 1002, and executes the process described above in accordance with the program.

The auxiliary storage device 1003 is an example of a non-transitory physical medium. Other examples of the non-transitory physical medium include a magnetic disk, a magneto-optical disk, a CD-ROM, a DVD-ROM, a semiconductor memory, and the like to be connected via the interface 1004. When the program is delivered to the computer 1000 through a communication line, the computer 1000 that has received the delivery may load the program in the main storage device 1002 to execute the process described above.

Further, the program may be for implementing a part of the process mentioned above. Furthermore, the program may be a differential program that implements the process described above in combination with another program already stored in the auxiliary storage device 1003.

A part of or all of each constituent element may be implemented by a general-purpose or dedicated circuitry, a processor, or the like, or a combination thereof. Those may be configured by a single chip, or may be configured by a plurality of chips connected via a bus. A part of or all of each constituent element may be implemented by a combination of the circuitry or the like mentioned above and a program.

In the case where a part of or all of each constituent element is implemented by a plurality of information processing apparatuses, circuitries, and the like, the plurality of information processing apparatuses, circuitries, and the like may be concentratedly disposed, or may be distributedly disposed. For example, the information processing apparatus, the circuitry, and the like may be implemented as a form in which each is connected via a communication network, such as a client and server system and a cloud computing system.

Next, an outline of the present invention will be described. FIG. 13 is a block diagram illustrating the outline of the automatic negotiation system according to the present invention. An automatic negotiation system 51 according to the present invention includes a supply utility function generation means 53, and a demand utility function generation means 55.

The automatic negotiation system 51 performs automatic negotiation with a consumer system (e.g., consumer system 21) managed by a consumer (e.g., consumer of power).

The supply utility function generation means 53 (e.g., supply utility function generator 3) generates a supply utility function indicating a change in a profit and loss of a supplier (e.g., power supplier) relative to a change in a total demand for each current time and future time.

The demand utility function generation means 55 (e.g., demand utility function generator 5) generates a demand utility function indicating a change in the profit and loss of the supplier relative to a change in a demand of a consumer for each current time and future time.

According to such a configuration, an indicator for defining a favorable target candidate for the supplier can be generated.

Further, the automatic negotiation system may include a negotiation means (e.g., negotiation unit 8) that determines a target candidate in negotiation using at least the demand utility function, presents the candidate to the consumer system, and performs automatic negotiation with the consumer system.

Furthermore, the negotiation means may determine the target candidate in the negotiation using the supply utility function and the demand utility function, present the candidate to the consumer system, and perform automatic negotiation with the consumer system.

FIG. 14 is a block diagram illustrating another example of the outline of the automatic negotiation system according to the present invention. The automatic negotiation system according to the present invention can also be illustrated as in FIG. 14. Note that a utility function can also be said to be a function expressing a relationship between desirability and a negotiation matter. The automatic negotiation system 51 includes a perturbative utility function generation means 57.

With respect to the utility function expressing a relationship between desirability for a first economic entity and a negotiation matter, the perturbative utility function generation means 57 derives the utility function from a relationship between an objective function and restriction in an optimized system managed by the first economic entity and a parameter and an optimum value dependent on a second economic entity.

Here, examples of the first economic entity include the supplier mentioned above. Examples of the second economic entity include the consumer mentioned above. Besides, the optimization here corresponds to profit maximization (=demand increase−supply decrease).

Although the present invention has been described with reference to the exemplary embodiments, the present invention is not limited to the exemplary embodiments described above. Various modifications that can be understood by those skilled in the art within the scope of the present invention can be made to the configuration and details of the present invention.

The present application claims priority based on Japanese Patent Application No. 2016-201784 filed on Oct. 13, 2016, the disclosure of which is incorporated herein in its entirety.

### INDUSTRIAL APPLICABILITY

The present invention is suitably applicable to an automatic negotiation system that performs automatic negotiation with a system managed by a consumer in favor of a supplier.

### REFERENCE SIGNS LIST

1 Automatic negotiation system
2 Supply state/plan storage unit
3 Supply utility function generator
4 Demand state/plan storage unit
5 Demand utility function generator
6 Utility function storage unit
7 Consumer storage unit
8 Negotiation unit
9 Negotiation controller

What is claimed is:

1. An automatic negotiation system managed by a first economic entity that performs automatic negotiation with a system managed by a second economic entity, the automatic negotiation system comprising:
a perturbative utility function generation unit, implemented by a processor, that derives, with respect to a utility function expressing a relationship between desirability for the first economic entity and a negotiation matter, the utility function from a relationship between an objective function and restriction in an optimized system managed by the first economic entity and a parameter and an optimum value dependent on the second economic entity.

2. An automatic negotiation system that performs automatic negotiation with a consumer system managed by a consumer, the automatic negotiation system comprising:
a supply utility function generation unit, implemented by a processor, that generates a supply utility function expressing a change in a profit and loss of a supplier relative to a change in a total demand for each current time and future time; and
a demand utility function generation unit, implemented by the processor, that generates a demand utility function expressing a change in the profit and loss of the supplier relative to a change in a demand of the consumer for each current time and future time.

3. The automatic negotiation system according to claim 2, further comprising:
a negotiation unit, implemented by the processor, that determines a target candidate in negotiation using at least the demand utility function, presents the candidate to a consumer system, and performs automatic negotiation with the consumer system.

4. The automatic negotiation system according to claim 3, wherein
the negotiation unit determines the target candidate in the negotiation using the supply utility function and the demand utility function, presents the candidate to the consumer system, and performs automatic negotiation with the consumer system.

5. An automatic negotiation method applied to an automatic negotiation system managed by a first economic entity, the system performing automatic negotiation with a system managed by a second economic entity, the automatic negotiation method comprising:
deriving, using the automatic negotiation system, with respect to a utility function expressing a relationship between desirability for the first economic entity and a negotiation matter, the utility function from a relationship between an objective function and restriction in an optimized system managed by the first economic entity and a parameter and an optimum value dependent on the second economic entity.

6.-12. (canceled)
